(19) United States
(12) Patent Application Publication
(10) Pub. No.: US 2026/0094527 A1
(43) Pub. Date: Apr. 2, 2026

(54) INTERACTIVE ACTIVITY GUIDE

(71) Applicant: Dustin Kringer, Rockledge, FL (US)

(72) Inventor: Dustin Kringer, Rockledge, FL (US)

(21) Appl. No.: 18/904,901

(22) Filed: Oct. 2, 2024

(51) Int. Cl. G09B 5/06; G06F 3/0482; G06F 3/0488; G06F 3/16

(52) U.S. Cl. CPC G09B 5/06; G06F 3/0482; G06F 3/0488; G06F 3/165

(57) ABSTRACT

An interactive activity guide includes a housing that has an ornamental structure which resembles an animal to appeal to the emotions of a child thereby encouraging the child to interact with the housing. A touch screen is integrated into the housing which displays a plurality of icons to enable the child to select a task that the child is to perform. A communication unit is integrated into the housing and the communication unit includes a speaker which audibly emits a respective one of a plurality of songs to encourage the child to complete the task associated with the respective icon. Each of the plurality of songs includes reminders of remaining time to complete the task associated with the respective icon to encourage the child to remain focused on completing the task associated with the respective icon.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to activity guide devices and more particularly pertains to a new activity guide device for encouraging a child to complete an activity within reasonable amount of time. The device includes a housing that is structured to have the ornamental appearance of an animal and a touch screen that is mounted to the housing which displays icons that can be selected by a child. The device includes a communication unit that is integrated into the housing and which is in communication with the touch screen. The communication unit stores a database comprising a plurality of songs that comprise motivational instructions for completing a task as well as reminders of the duration of time that remains to complete the task.

### (2) Description of Related Art Including Information Disclosed Under 37 CFR 1.97 and 1.98

The prior art relates to activity guide devices including: an interactive toy device that includes wireless communication with an extrinsic communication network which can record a verbal message and subsequently play the verbal message; a system and method for tailoring music to an activity which includes a database of songs that each includes a tempo to guide a user to perform a task and a feedback system to determine if the user is accomplishing the task in accordance with the tempo; a child learning device that includes a housing which is structured to have the ornamental appearance of an animal and a countdown timer and a driving mechanism which animates a movable appendage on the housing; an electronic health and nutrition toy that teaches children the importance of eating healthy foods and engaging in physical activity; an programable interactive system that includes a housing structured to resemble an animal and an input sensor for sensing behavior of a user and an output device which analyses behavior of the user. In no instance does the prior art disclose an interactive task device that includes a housing structured to resemble an animal and a touch screen which displays icons related to tasks to be performed by a child and an electronic memory which stores a plurality of songs that are each related to a respective icon to encourage the child to complete a task and a verbal reminder of a duration of time remaining to complete the task.

### (h) BRIEF SUMMARY OF THE INVENTION

An embodiment of the disclosure meets the needs presented above by generally comprising a housing that has an ornamental structure which resembles an animal to appeal to the emotions of a child thereby encouraging the child to interact with the housing. A touch screen is integrated into the housing which displays a plurality of icons to enable the child to select a task that the child is to perform. A communication unit is integrated into the housing and the communication unit includes a speaker which audibly emits a respective one of a plurality of songs to encourage the child to complete the task associated with the respective icon. Each of the plurality of songs includes reminders of remaining time to complete the task associated with the respective icon to encourage the child to remain focused on completing the task associated with the respective icon.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an interactive activity guide according to an embodiment of the disclosure.

FIG. 2 is a back phantom view of an embodiment of the disclosure.

FIG. 3 is a left side view of an embodiment of the disclosure.

FIG. 4 is a front view of a touch screen of an embodiment of the disclosure.

FIG. 5 is a schematic view of an embodiment of the disclosure.

FIG. 6 is perspective in-use view of an embodiment of the disclosure.

### (J) DETAILED DESCRIPTION OF THE INVENTION

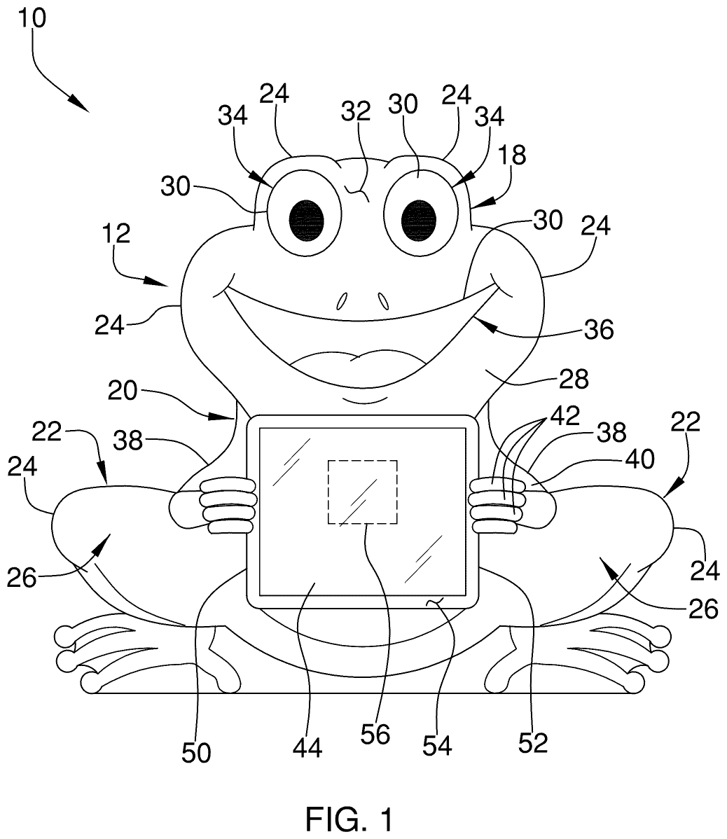

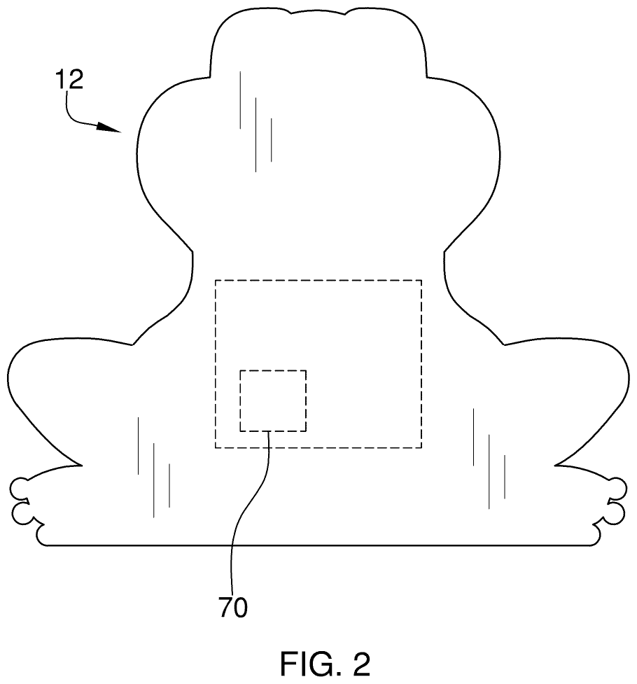

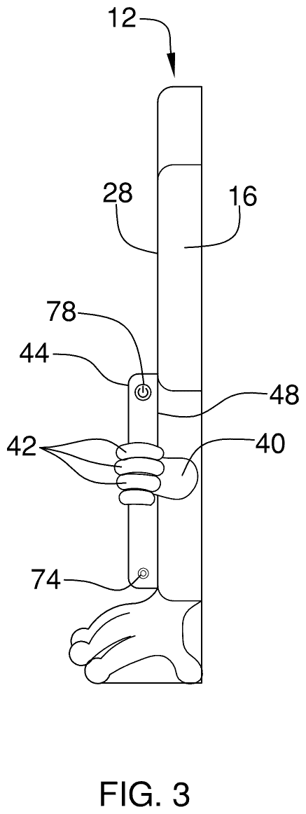

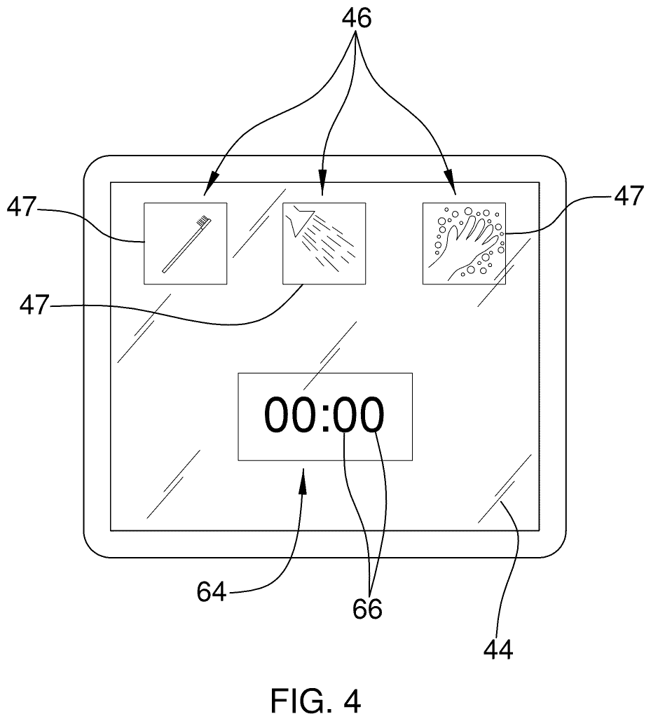

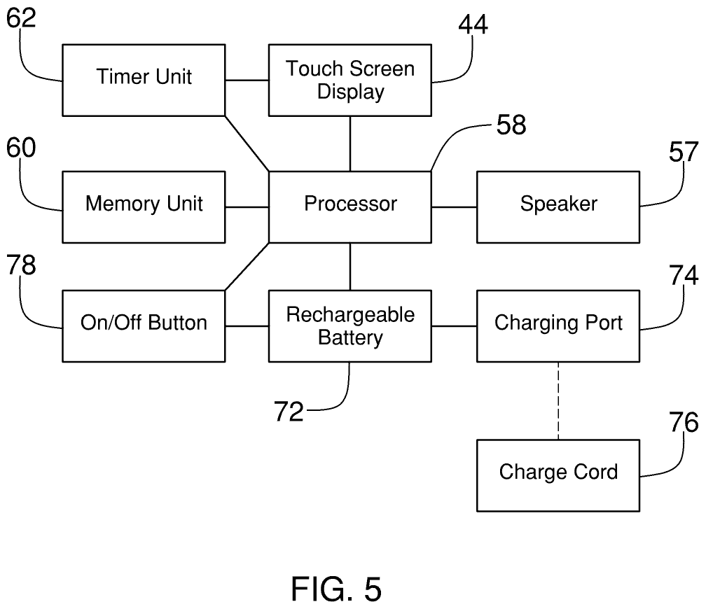

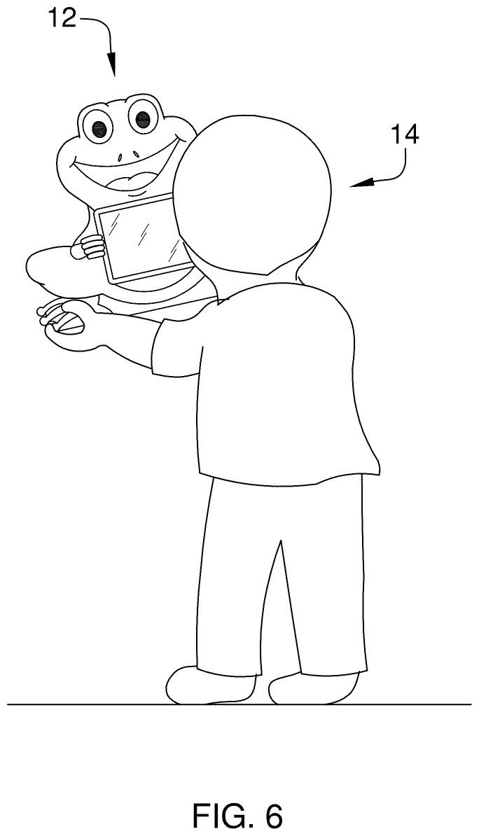

With reference now to the drawings, and in particular to FIGS. 1 through 6 thereof, a new activity guide device embodying the principles and concepts of an embodiment of the disclosure and generally designated by the reference numeral 10 will be described.

As best illustrated in FIGS. 1 through 6, the interactive activity guide 10 generally comprises a housing 12 which has an ornamental structure that resembles an animal. In this way the housing 12 appeals to the emotions of a child 14 thereby encouraging the child 14 to interact with the housing 12. The housing 12 has a perimeter edge 16 which is structured to define the outline of the animal which includes a head 18 of the animal and a body 20 of the animal and appendages 22 of the animal. In this way the perimeter edge 16 enables the housing 12 to closely resemble the real life appearance of the animal thereby enhancing the child's 14 attraction to the housing 12. As is shown in FIGS. 1 through 3, the housing 12 may have the ornamental appearance of a frog. However, the housing 12 might be structured to have the ornamental appearance of any animal that is typically pleasing to children, including but not being limited to, a bear, a horse, or a fish.

The perimeter edge 16 has a series of lobes 24 that are each strategically oriented to define the head 18 of the animal and legs 26 of the animal and outer physical characteristics of the animal. The housing 12 has a front wall 28 and the housing 12 has facial indicia 30 which are applied to a front surface 32 of the front wall 28 which comprise a pair of eyes 34 of the animal and a mouth 36 of the animal to enhance the realistic appearance of the animal. The front wall 28 has pair of protrusions 38 which each extend forwardly from the front surface 32 of the front wall 28. Each of the pair of protrusions 38 is structured to define an arm 40 of the animal and a plurality of fingers 42 of the animal. Furthermore, the protrusions 38 are spaced apart from each other having the fingers 42 associated with each of the pair of protrusions 38 being directed toward each other.

A touch screen 44 is integrated into the housing 12 such that the touch screen 44 is visible to the child 14. The touch screen 44 displays menu indicia 46 comprising icons 47 which visually represent various tasks to be performed by the child 14. In this way the menu indicia 46 enable the child 14 to select a task that the child 14 is to perform. The task may be a task related to personal hygiene, such as brushing teeth or bathing or washing hands or any other type of task that children are regularly required to perform and which children can often struggle with accomplishing without constant reminders from a caregiver.

A rear surface 48 of the touch screen 44 is mounted to the front surface 32 of the front wall 28 of the housing 12. Furthermore, the touch screen 44 is positioned between the pair of protrusions 38 on the front wall 28 of the housing 12 such that the plurality of fingers 42 associated with each of the pair of protrusions 38 is attached to a respective one of a first lateral side 50 and a second lateral side 52 of the touch screen 44. In this way each of the plurality of fingers 42 presents the ornamental appearance of the animal holding the touch screen 44 thereby enhancing the child's 14 ability to imagine that the animal is holding the touch screen 44. Additionally, each of the plurality of fingers 42 extends onto a forward surface 54 of the touch screen 44. The touch screen 44 may comprise a light emitting diode touch screen or any other type of electronic display that can not only display color imagery but is also responsive to being touched.

A communication unit 56 is integrated into the housing 12 and the communication unit 56 is in communication with the touch screen 44. The communication unit 56 stores a database which comprises a plurality of songs which each corresponds to a respective one of the icons 47 of the menu indicia 46. Additionally, the communication unit 56 includes a speaker which is actuated to audibly emit a respective one of the plurality of songs which corresponds to the respective icon 47 when the respective icon 47 is selected by the child 14. In this way the communication unit 56 can encourage the child 14 to complete the task associated with the respective icon 47. Each of the plurality of songs includes reminders of remaining time to complete the task associated with the respective icon 47. In this way the plurality of songs can encourage the child 14 to remain focused on completing the task associated with the respective icon 47.

The communication unit 56 comprises a processor 58 which is integrated into the housing 12 and the processor 58 is electrically coupled to the touch screen 44. An electronic memory 60 is integrated into the housing 12 which stores the database comprising the plurality of songs and each of the plurality of icons 47 and the electronic memory is in electrical communication with the processor 58. Additionally, a respective one of the plurality of songs in the database which is associated with the respective icon 47 that is displayed on the touch screen 44 is played when the respective icon 47 displayed on the touch screen 44 is chosen by the child 14. The communication unit 56 includes an electronic timer 62 which is integrated into the housing 12 and the electronic timer 62 is electrically coupled to the processor 58. The electronic timer 62 is actuated to count down a duration of time which corresponds to the reminder of remaining time to complete the task associated with the respective icon 47. Additionally, the touch screen 44 displays timer indicia 64 comprising numbers 66 which indicate the duration of time that is counted down by the electronic timer 62. In this way the timer indicia 64 can visually indicate the remaining time to complete the task associated with the respective icon 47 to the child 14.

The speaker 57 is electrically coupled to the processor 58 such that the speaker 57 audibly emits the respective song in the electronic memory 60 when the respective icon 47 displayed on the touch screen 44 is chosen by the child 14. In this way the speaker 57 can enable the child 14 to hear the respective song. Furthermore, the speaker 57 may comprise an electronic speaker of any conventional design which has an output intensity that is appropriate to enable the child 14 to clearly hear the respective song without being unreasonably loud.

The communication unit 56 includes a power supply 70 that is integrated into the housing 12 and the power supply 70 is electrically coupled to the processor 58. The power supply 70 comprises a rechargeable battery 72 which is positioned within the housing 12 and the rechargeable battery 72 is electrically coupled to the processor 58. The power supply 70 includes a charge port 74 which is recessed into the second lateral side 52 of the touch screen 44 thereby enabling the charge port 74 to insertably receive a charge cord 76 for charging the rechargeable battery 72. The power supply 70 includes a power button 78 which is movably integrated into the second lateral side 52 of the touch screen 44 such that the power button 78 can be manipulated by the child 14. The power button 78 is electrically coupled to the processor 58 and the power button 78 actuates the processor 58 when the power button 78 is depressed an initial time. Additionally, the power button 78 de-actuates the processor 58 when the power button 78 is depressed a subsequent time.

In use, the housing 12 is placed in a location where the child 14 will be expected to perform the various tasks and the touch screen 44 displays the icons 47 associated with the various tasks to be performed by the child 14. The child 14 touches one of the icons 47 that is associated with the task that the child 14 is to perform and the speaker 57 begins to play the song that is associated with the task that the child 14 has selected. Additionally, the touch screen 44 begins to display the timer indicia 64 to remind the child 14 of the duration of time that remains to complete the task. The song that is associated with the task that the child 14 has selected includes motivational statements as well as periodic reminders of how much time remains which corresponds to the timer indicia 64. In this way the child 14 can be motivated to remain focused on completing the task that the child 14 has selected without being required to be continually reminded by the caregiver to complete the task. Thus, the child 14 can not only be motivated to complete the task in a timely manner but can also learn to remain focused on completing tasks to ensure the child 14 develops the maturity and focus necessary to be successful in life.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interactive activity guide device for motivating a child to perform a selected activity while playing a motivational song, said device comprising:
a housing having an ornamental structure which resembles an animal wherein said housing is configured to encourage the child to interact with said housing;
a touch screen being integrated into said housing, wherein said touch screen is configured to be visible to the child, said touch screen displaying menu indicia comprising icons which visually represent various tasks to be performed by the child wherein said menu indicia are configured to enable the child to select a task that the child is to perform; and
a communication unit being integrated into said housing, said communication unit being in communication with said touch screen, said communication unit storing a database comprising a plurality of songs which each corresponds to a respective one of said icons of said menu indicia, said communication unit including a speaker which is actuated to audibly emit a respective one of said plurality of songs which corresponds to said respective icon when said respective icon is selected by the child wherein said communication unit is configured to encourage the child to complete the task associated with said respective icon, each of said plurality of songs including reminders of remaining time to complete the task associated with said respective icon wherein said plurality of songs is configured to encourage the child to remain focused on completing the task associated with said respective icon.

2. The interactive activity guide device according to claim 1, wherein:
said housing has a perimeter edge which is structured to define the outline of the animal which includes a head of the animal and a body of the animal and appendages of the animal wherein said perimeter edge is configured to enable said housing to closely resemble the real life appearance of the animal thereby enhancing the child's attraction to said housing;
said housing has a front wall; and
said housing has facial indicia being applied to a front surface of said front wall comprising a pair of eyes of the animal and a mouth of the animal wherein said facial indicia are configured to enhance the realistic appearance of the animal.

3. The interactive activity guide device according to claim 2, wherein
said front wall has pair of protrusions which each extend forwardly from said front surface of said front wall;
each of said pair of protrusions being structured to define an arm of the animal and a plurality of fingers of the animal;
said pair of protrusions is spaced apart from each other having said fingers associated with each of said pair of protrusions being directed toward each other.

4. The interactive activity guide device according to claim 3, wherein:
a rear surface of said touch screen is mounted to said front surface of said front wall of said housing;
said touch screen is positioned between said pair of protrusions on said front wall of said housing such that said plurality of fingers associated with each of said pair of protrusions is attached to a respective one of a first lateral side and a second lateral side of said touch screen wherein each of said plurality of fingers is configured to present the ornamental appearance of the animal holding said touch screen thereby enhancing the child's ability to imagine that the animal is holding said touch screen; and
each of said plurality of fingers extends onto a forward surface of said touch screen.

5. The interactive activity guide device according to claim 1, wherein:
said communication unit comprises a processor being integrated into said housing;
said processor is electrically coupled to said touch screen;
said communication unit includes an electronic memory which stores said database comprising said plurality of songs and each of said plurality of icons; and
said electronic memory is in electrical communication with said processor.

6. The device according to claim 5, wherein a respective one of said plurality of songs in said database which is associated with said respective icon that is displayed on said touch screen is played when said respective icon displayed on said touch screen is chosen by the child.

7. The interactive activity guide device according to claim 5, wherein:
said communication unit includes an electronic timer integrated into said housing;
said electronic timer is electrically coupled to said processor;
said electronic timer is actuated to count down a duration of time which corresponds to said reminder of remaining time to complete the task associated with said respective icon; and
said touch screen displays timer indicia comprising numbers which indicate said duration of time being counted down by said electronic timer wherein said timer indicia are configured to visually indicate the remaining time to complete the task associated with said respective icon to the child.

8. The interactive activity guide device according to claim 6, wherein:
said speaker is integrated into said housing wherein said speaker is configured to emit audible sounds outwardly from said housing;
said speaker is electrically coupled to said processor such that said speaker audibly emits said respective song in said electronic memory when said respective icon displayed on said touch screen is chosen by the child wherein said speaker is configured to enable the child to hear said respective song.

9. The interactive activity guide device according to claim 5, wherein:
said touch screen has a first lateral side and a second lateral side;
said communication unit includes a power supply being integrated into said housing;
said power supply is electrically coupled to said processor;
said power supply comprises:
a rechargeable battery being positioned within said housing, said rechargeable battery being electrically coupled to said processor;
a charge port being recessed into said second lateral side of said touch screen thereby enabling said charge port to insertably receive a charge cord for charging said rechargeable battery; and
a power button being movably integrated into said second lateral side of said touch screen wherein said power button is configured to be manipulated by the child, said power button being electrically coupled to said processor, said power button actuating said processor when said power button is depressed an initial time, said power button de-actuating said processor when said power button is depressed a subsequent time.

10. An interactive activity guide device for motivating a child to perform a selected activity while playing a motivational song, said device comprising:
a housing having an ornamental structure which resembles an animal wherein said housing is configured to encourage the child to interact with said housing, said housing having a perimeter edge which is structured to define the outline of the animal which includes a head of the animal and a body of the animal and appendages of the animal wherein said perimeter edge is configured to enable said housing to closely resemble the real life appearance of the animal thereby enhancing the child's attraction to said housing, said housing having a front wall, said housing having facial indicia being applied to a front surface of said front wall comprising a pair of eyes of the animal and a mouth of the animal wherein said facial indicia are configured to enhance the realistic appearance of the animal, said front wall having pair of protrusions which each extend forwardly from said front surface of said front wall, each of said pair of protrusions being structured to define an arm of the animal and a plurality of fingers of the animal, said pair of protrusions being spaced apart from each other having said fingers associated with each of said pair of protrusions being directed toward each other;
a touch screen being integrated into said housing, wherein said touch screen is configured to be visible to the child, said touch screen displaying menu indicia comprising icons which visually represent various tasks to be performed by the child wherein said menu indicia are configured to enable the child to select a task that the child is to perform, a rear surface of said touch screen being mounted to said front surface of said front wall of said housing, said touch screen being positioned between said pair of protrusions on said front wall of said housing such that said plurality of fingers associated with each of said pair of protrusions is attached to a respective one of a first lateral side and a second lateral side of said touch screen wherein each of said plurality of fingers is configured to present the ornamental appearance of the animal holding said touch screen thereby enhancing the child's ability to imagine that the animal is holding said touch screen, each of said plurality of fingers extending onto a forward surface of said touch screen;
a communication unit being integrated into said housing, said communication unit being in communication with said touch screen, said communication unit storing a database comprising a plurality of songs which each corresponds to a respective one of said icons of said menu indicia, said communication unit including a speaker being actuated to audibly emit a respective one of said plurality of songs which corresponds to said respective icon when said respective icon is selected by the child wherein said communication unit is configured to encourage the child to complete the task associated with said respective icon, each of said plurality of songs including reminders of remaining time to complete the task associated with said respective icon wherein said plurality of songs is configured to encourage the child to remain focused on completing the task associated with said respective icon, said communication unit comprising:
a processor being integrated into said housing, said processor being electrically coupled to said touch screen;
an electronic memory being integrated into said housing which stores said database comprising said plurality of songs and each of said plurality of icons, said electronic memory being in electrical communication with said processor, a respective one of said plurality of songs in said database which is associated with said respective icon that is displayed on said touch screen is played when said respective icon displayed on said touch screen is chosen by the child;
an electronic timer being integrated into said housing, said electronic timer being electrically coupled to said processor, said electronic timer being actuated to count down a duration of time which corresponds to said reminder of remaining time to complete the task associated with said respective icon, said touch screen displaying timer indicia comprising numbers which indicate said duration of time being counted down by said electronic timer wherein said timer indicia are configured to visually indicate the remaining time to complete the task associated with said respective icon to the child; and
a power supply being integrated into said housing, said power supply being electrically coupled to said processor, said power supply comprising:
a rechargeable battery being positioned within said housing, said rechargeable battery being electrically coupled to said processor;
a charge port being recessed into said second lateral side of said touch screen thereby enabling said charge port to insertably receive a charge cord for charging said rechargeable battery; and
a power button being movably integrated into said second lateral side of said touch screen wherein said power button is configured to be manipulated by the child, said power button being electrically coupled to said processor, said power button actuating said processor when said power button is depressed an initial time, said power button de-actuating said processor when said power button is depressed a subsequent time; and
wherein said speaker is integrated into said housing wherein said speaker is configured to emit audible sounds outwardly from said housing, said speaker being electrically coupled to said processor such that said speaker audibly emits said respective song in said electronic memory when said respective icon displayed on said touch screen is chosen by the child wherein said speaker is configured to enable the child to hear said respective song.
